(19) United States
(12) Patent Application Publication
(10) Pub. No.: US 2021/0285580 A1
(43) Pub. Date: Sep. 16, 2021

(54) Adjustable Expansion Spool

(71) Applicant: Utex Industries, Inc., Houston, TX (US)

(72) Inventor: Todd Travis, Humble, TX (US)

(73) Assignee: Utex Industries, Inc., Houston, TX (US)

(21) Appl. No.: 16/817,857

(22) Filed: Mar. 13, 2020

(51) Int. Cl. F16L 27/12; F16L 23/036; F16L 21/02

(52) U.S. Cl. CPC F16L 27/12; F16L 21/02; F16L 23/036

(57) ABSTRACT

The invention comprises an expansion spool in which a pipe connected between two mounting pieces of the spool is cut to one of a plurality of suitable lengths for mounting between an open gap in a pipeline to create a stable fluid connection. The pipe has disposed therein a plurality of spaced and shaped grooves in which to insert a shaped split ring. A separate flange mounted over each shaped split ring imposes compressive but not shear forces on the shaped split ring. One mount has disposed therein a recess to permit variable insertion depths of the pipe so as to permit the spool to span variable gap lengths. The mounts, clamps, split rings and pipe combine to create an expansion spool suitable for low pressure and high-pressure pipelines.

### FIELD OF THE INVENTION

The present invention is an adjustable expansion spool used to connect pipes in oil fields and which is designed for use in low or high pressure pipelines in which the invention is secured between an open gap in a pipeline to create a fluid connection between the ends of the open gap and, further, in which the invention is length adjustable to fit a gap of undetermined size. While expansion spools are typically limited to use only in low pressure pipelines, the present invention includes a shearless split ring design element which enables the expansion spool to be securely used in low pressure and high-pressure pipelines.

### BACKGROUND OF THE INVENTION

Expansion spools are commonly used in oil field pipelines to provide secure connections between sections of pipelines that are subject to expansion and deformation based on temperature and pressure variations experienced in the pipeline. At the same time, expansion spools are commonly removable from the pipeline to permit maintenance. They are replaced or reinstalled once maintenance is completed.

Expansion spools known in the field commonly take the form of an arched, durable, flexible rubberized expansion element fitted between two flanges suitable to be attached to mated flanges on two open ends of a pipeline. The known form of expansion spool, based on the construction of the arched, durable and flexible rubberized expansion element, can expand, contract and deform to ensure a secure fit in a low-pressure pipeline. One limitation of the known form of expansion spool is that the size of the gap connected by the expansion spool is limited based on the strength of the expansion element. Second, in order to prevent excessive expansion or blowout, the expansion spool may be used only with low pressure pipelines.

It is possible to construct a more durable expansion spool from metal, but these have typically been made from a single piece of metal in which a length of pipe has disposed on each end thereof a flange suitable to be connected to mated flanges on the open ends of the pipeline to be connected. Given common construction practices for oil pipelines in which different sections of pipelines are built separately, each such metal expansion spool must be manufactured to the specific length of the gap to be filled in the pipeline. The size of the gap may not be known until the pipeline is otherwise completed. In the event of a temperature variation between when the size of the gap is measured and when the metal spool is installed, the spool custom made to fit that gap may no longer fit owing to metal expansion from heat (or contraction from cold). Thus, constructing an expansion spool to fit a specific pipeline gap can be hit-or-miss.

A third option to make an expansion spool is to construct it onsite. This requires workers to take tools (for example, pipe cutters and welding equipment) into the field with pipes and flanges to construct a suitable spool on the spot. While it allows a properly-size expansion spool to be made, it is labor intensive. Since the site where the spool is to be installed may be in a remote region, workers may have to bring generators and other heavy equipment. While making an expansion spool onsite may be the best option outside the present invention for making an expansion spool that fits the gap, this option is the most expensive option.

There is a need for an adjustable expansion spool suitable to connect pipeline gaps where only an approximate length of pipe to be connected is known. There is a further need for an adjustable expansion spool suitable for use in high-pressure pipelines. And there is a need for a cost-effective expansion spool which meets these requirements. The disclosed invention fits these needs.

### BRIEF SUMMARY OF THE INVENTION

The primary elements of the invention include a first mounting piece, a main pipe and a second mounting piece. The invention further comprises two detached flanges used to mount the main pipe to the first and second mounting pieces and two split rings used to establish a stable mounting of the first and second mounting pieces to the main pipe when disposed against the detached flanges. Disposed on the main pipe is a plurality of spaced and shaped grooves. Each of the spaced and shaped grooves is shaped to permit the secure partial insertion of a split ring which is shaped to fit partially and securely into the spaced and shaped groove. Each of the separate flanges has disposed within the central hole thereof a shaped recess to permit the separate flange to be assembled over the shaped split ring in place in a shaped groove as well as over the main pipe. For clarity, part of each split ring fits in the shaped groove of the main pipe while part of the split ring extends above the outer surface of the main pipe so as to be engageable iii the shaped recess of the separate flange.

The shapes of the shaped split ring and the shaped groove, when mounted using the separate flange, ensures the separate flange and shaped split ring hold those parts in place with each of the mounting pieces through the application of compressive forces but not shear forces. This ensures the invention, when assembled using sealing rings, can be used in high-pressure pipelines.

The first mounting piece is a substantially cylindrical hollow tube comprising a central fluid passage with a diameter substantially equal to the inner diameter of the pipeline and a recess of larger diameter to permit insertion of one end of the main pipe. The first mounting piece further comprises two flanges placed first to attach the invention to a flange on one open end of the pipeline and the second to affix the first mounting piece to a separate flange mounted over the shaped split ring in a shaped groove proximate the end of the main pipe inserted into the first mounting piece.

The second mounting piece is also a substantially cylindrical hollow tube comprising a central fluid passage of equal diameter as the central fluid passage of the first mounting piece and a larger-diameter recess of equal diameter as the similar recess in the first mounting piece. The recess of the second mounting piece is substantially longer than the similar recess of the first mounting piece in order to accommodate more of the main pipe than the first mounting piece. Specifically, the second mounting piece is designed to permit as much of the main pipe as necessary to permit the assembled first mounting piece, main pipe and second mounting piece to span the gap in the pipeline. When assembled, the main pipe must extend from the second mounting piece sufficiently to expose at least one shaped groove proximate to the second mounting piece so as to permit the second mounting piece to be secured to the main pipe using the shaped split ring and separate flange.

In the preferred embodiment, flanges are attached to other flanges in proper order using standard nuts and bolts or nuts and threaded rods. For this, flanges are drilled with through-holes. In other embodiments, some flanges are drilled with blind holes to permit assembly using bolts but not nuts. The first mounting piece has disposed within the recess of the first mounting piece a plurality of grooves to permit seals to be disposed between the main pipe and first mounting piece.

The main pipe may be manufactured in different sizes. Workers going to the pipeline field to install the spool would take an appropriately sized length of main pipe which need be only approximately the correct size.

### BRIEF DESCRIPTION OF THE DRAWINGS

FIG. 1 depicts an expansion spool known in the field.

FIG. 2 depicts a cut-away side view of an exploded view of the primary elements of the invention.

FIG. 3 depicts a cut-away partial view of the first mounting piece depicting the recess thereof.

FIG. 4 depicts a partial cut-away side view of the end of the main pipe to be inserted into the recess of the first mounting piece.

FIG. 5 depicts a view of the main pipe of the invention viewed down the long axis thereof from the end to be inserted into the recess of the first mounting piece.

FIG. 6 depicts a cut-away side view of one length of the main pipe.

FIG. 7 depicts a side view of the shaped split ring used in the invention.

FIG. 8 depicts a cut-away view of the shaped split ring along line A-A depicted in FIG. 7.

FIG. 9 depicts a partial cut-away view of the shaped split ring showing details of the hexagonal shape thereof.

FIG. 10 depicts a view down the longitudinal axis of the recess end of the second mounting piece further depicting the flange thereof.

FIG. 11 depicts a cut-away side view of the second mounting piece.

FIG. 12 depicts a cut-away side view of the assembled first mounting piece, main pipe, second mounting piece, shaped split rings associated with each mounting piece and two separate flanges showing the configuration of the parts of the invention.

FIG. 13 depicts the invention in place in a section of oil field pipeline.

### DETAILED DESCRIPTION OF THE INVENTION

The figures and description of the invention disclosed herein are provided for the purpose of disclosing the preferred and other embodiments of the invention but do not limit the scope of the invention.

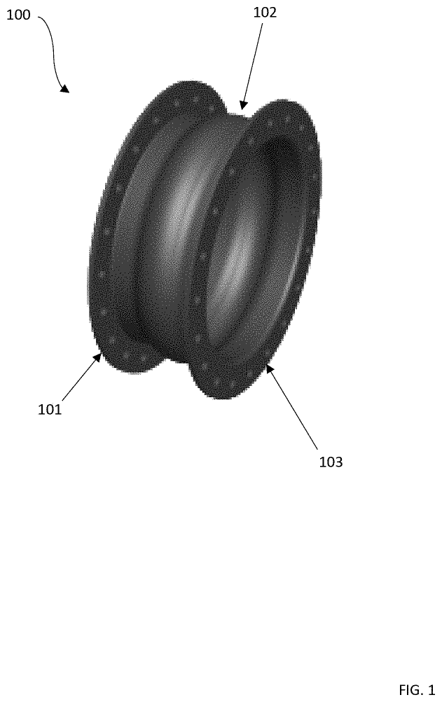

Referring first to FIG. 1, an expansion spool 100 known in the field is depicted. The expansion spool 100 comprises a first flange 101, a central expansion element 102 and a second flange 103. The first flange 101 and second flange 103 have disposed on, each a plurality of holes 104 suitable to permit each flange 101 and 102 to be bolted to a flange of the same size and hole configuration at the ends of a pipeline gap. The central expansion element 102 is fixedly mounted between the first flange 101 and second flange 102 so as to permit fluid connection from a first end of the pipeline, through the expansion spool 100 and into the second end of the pipeline. The flexible central expansion element 102 may be made from one or more of rubber or other pliable material, metal meshes and/or other flexible materials. In the event the pipeline to which the expansion spool 100 is connected expands, contracts or is subjected to torque, the expansion element 102 will expand, contract or skew to maintain the fluid connection of the expansion spool 100 to the pipeline.

This known form of expansion spool has limitations. First, it may not typically be used for long gaps in pipelines. Second, it may be used only in low pressure pipelines. Any high-pressure application will typically exceed the pressure capacity of the expansion element 102.

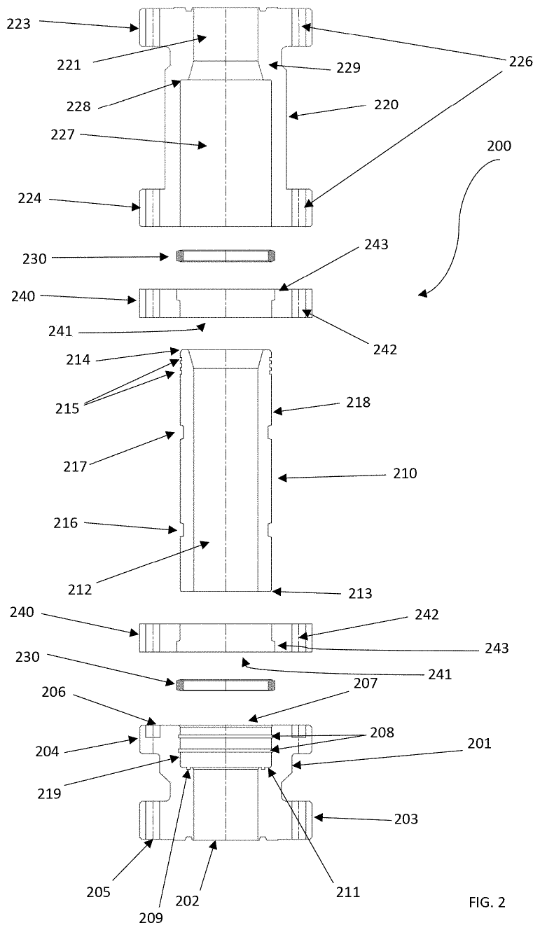

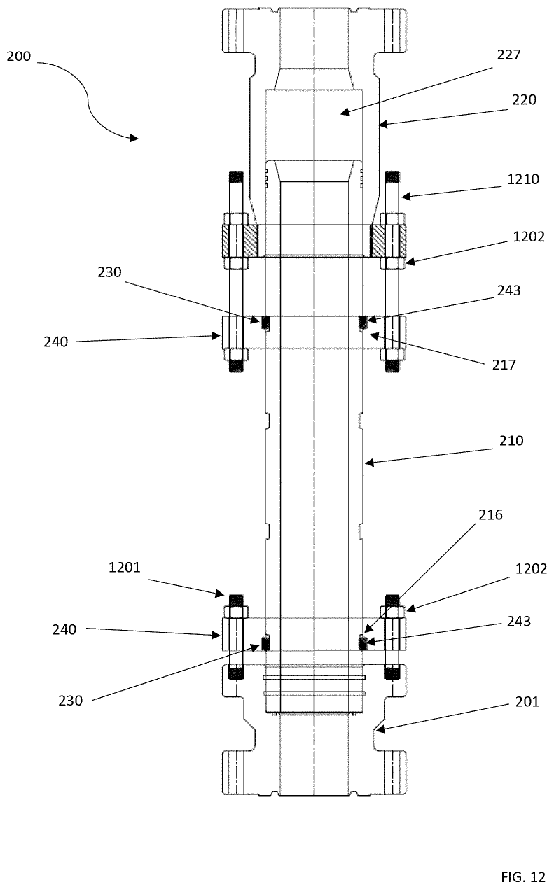

Referring now to FIG. 2, a cut-away and exploded side view of the parts of the invention 200 are depicted. For reference, it is noted the invention 200, when assembled and in use, is mounted between a gap in a pipeline to permit the flow of fluid through a first end of the pipeline, into and through the invention 200, and into the second end of the pipeline. The assembled parts of the invention 200 are depicted in FIG. 12. The invention 200 comprises a first mounting piece 201. The first mounting piece 201 is generally cylindrical in shape with a fluid passage 202 running along its longitudinal axis. The first mounting piece 201 has a first end at which is disposed a first flange 203. The first flange 203 has disposed thereon a plurality of through-holes 205 suitable to permit the first mounting piece 201 to be attached to a flange on one end of a gap in a pipeline (not depicted).

First mounting piece 201 has a second end at which is disposed a second, flange 204. Second flange 204 has disposed there on a plurality of blind holes 206 for mounting other elements of the invention 200 to the first mounting piece 201 using bolts. In other embodiments, the blind holes 206 may be through holes for use with nuts and bolts.

At the second end of the first mounting piece 201, the fluid passage 202 further comprises a recess 207, which is a larger bore in the second end of the first mounting piece 201. Recess 207 is positioned coaxially to fluid passage 202 but has a larger diameter. Specifically the diameter of the recess 207 is sized to match the outer diameter of the main pipe 210 of the invention 200. The recess 207 also has disposed on its side wall 219 a plurality of side seal grooves 208 to seal the connection between the main pipe 210 and the first mounting piece 201. Further, the recess 207 has a bottom 211 on which is disposed a bottom seal groove 209 to provide sealing between the main pipe 210 and the first mounting piece 201. As can be seen from the position of the side seal grooves 208 and, in particular, bottom seal groove 209, the end of main pipe 210 inserted into the recess 207 of the first mounting piece 201 is fully inserted until the end of the main pipe 210 makes sealed contact with the bottom 211 of the recess 207.

The main pipe 210 is a generally cylindrical hollow tube having a first end and a second end. In this description, the first end of the main pipe 210 is associated with recess 207 of the first mounting piece 201 and the second end of the main pipe 210 is associated with the recess 227 of the second mounting piece 220. The main pipe 210 has disposed concentrically along its longitudinal axis a fluid passage 212 of substantially the same diameter as the fluid passage 202 of the first mounting piece 201. By maintaining the same diameter between those parts there is a reduced likelihood of turbulence or non-linear flow developing in the pipeline during operations as fluids flow from the first mounting piece 201 and into the main pipe 210.

The outer rim of the first end of the main pipe 210 has disposed thereon a bevel 213 to aid insertion of the first end of the main pipe 210 into recess 207 of the first mounting piece 201. At the second end of the main pipe 210 there is a similar bevel 214 disposed to aid insertion of the second end of the main pipe 210 into the second mounting piece 220. In addition, the second end of the main pipe 210 has disposed thereon a plurality of seal grooves 215 for seals to seal the connection between the second end of the main pipe 210 and the second mounting piece 220.

The main pipe 210 has an outer cylindrical surface 218 on which is disposed a first split ring groove 216 and a second split ring groove 217. First split ring groove 216 and second split ring groove 217 are shaped, as described hereinbelow, to accommodate shaped split rings 230 used to assemble the invention 200 securely.

The invention 200 further comprises two separate flanges 240 used to secure each of the first mounting piece 201 and the second mounting piece 220 in place with the main pipe 210. Each separate flange 240 is a generally flat disk in shape with a plurality of through holes 242 sized and positioned and in a number sufficient to permit one separate flange 240 to be bolted into place with each of the first mounting piece 201 and the second mounting piece 220. Each separate flange 240 further has disposed centered on its longitudinal axis a hole 241 sized to permit each separate flange 240 to have the main pipe 210 inserted through the hole 241 for assembly of the invention 200. The hole 241 of each separate flange 240 has further disposed therein a cut-out section referred to as the flange groove 243 sized and shaped to secure a split ring 230, as described more fully hereinbelow.

The invention 200 further comprises a second mounting piece 220. Second mounting piece 220 has a generally cylindrical shape similar to that of first mounting piece 201, although second mounting piece 220 is longer along the longitudinal axis of the second mounting piece 220 than is the first mounting piece 201. Second mounting piece 220 has disposed through its longitudinal axis a fluid passage 221 having a diameter substantially the same as the diameter of the fluid passage 202 of the first mounting piece 201. As with the first mounting piece 201, the second mounting piece 220 has a first end at which is disposed a first flange 223 and a second end at which is disposed a second flange 224. Each of the first flange 223 and second flange 224 of the second mounting piece 220 have disposed thereon a plurality of through holes 226 to permit assembly and mounting of the invention 200. The second mounting piece 220 has disposed along its longitudinal axis a recess 227 which is a cylindrical hole having a diameter sized to match the outer diameter of the main pipe 210. The recess 227 of the second mounting piece 210 has a bottom 228. In addition, connecting the fluid passage 221 of the second mounting piece 220 to the recess 227 is a flared region 229 having an expanding diameter starting with the diameter of the fluid passage 221 and flaring out to the inner edge of the recess bottom 228.

The first mounting piece 201 has a length which is determined by the need to dispose on the outer surface of the first mounting piece 201 the first flange 203 and second flange 204 while permitting workers to perform operations to use the first mounting piece 201 in the invention 200. The length of the first mounting piece 201 must be sufficient to permit the recess 207 to be deep enough to securely engage the main pipe 210 and seal therefor. Said for clarity, the length of first mounting piece 201 is determined primarily by the need for workers to thread bolts or nuts and bolts onto the first flange 203 and second flange 204 to assemble the invention 200 and to mount the first mounting piece 201 to one end of the pipeline in which the invention 200 is used, Typically, the depth of recess 207 of the first mounting piece 201 is sufficiently less than the working parameters of the first flange 203 and second flange 204 such that the depth of the recess 207 is not determinative of the length of first mounting piece 201.

Contrarily, the length of the second mounting piece 220 is determined primarily by the need to have the recess 227 of the second mounting piece 220 long enough to engage as much or as little of the main pipe 210 as necessary to permit the invention 200, when assembled, to span the gap in the pipeline as needed without having to cut the main pipe 210 in the field while likewise allowing main pipe 210 to be securely affixed to the second mounting piece 220. Gaps in pipelines may come in a number of lengths, from approximately 2 feet to 20 feet. The main pipe 210 is manufactured in diverse, discrete lengths such that, when mounted in the first mounting piece 201 and the second mounting piece 220 the invention, the main pipe 210 can fully span the gap. Typically, the main pipe 210 is made in lengths of approximately 2 ft, 3 ft, 4 ft. and so forth up to 20 feet. These lengths are not a limitation of the invention.

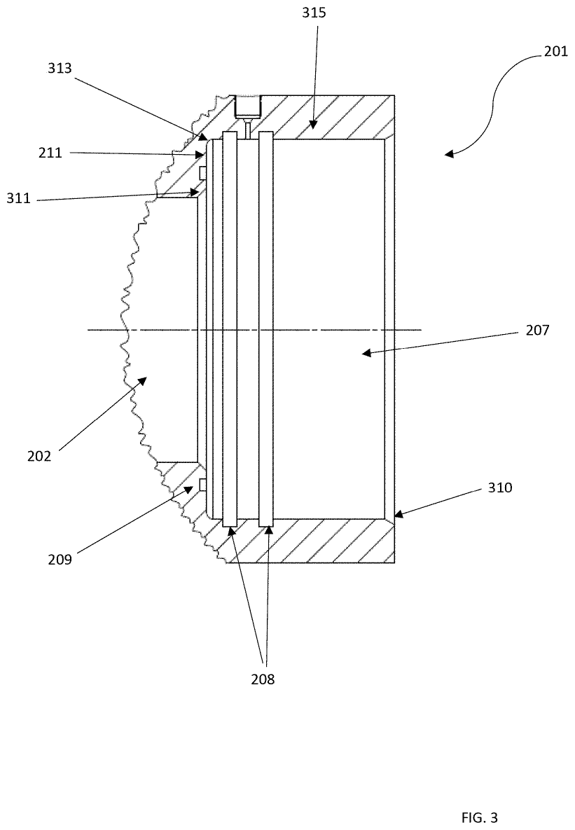

Referring now to FIG. 3, a partial cut-away side view of the first mounting piece 201 is depicted. This figure further depicts recess 207 and fluid passage 202. The dotted line in FIG. 3 represents the imaginary longitudinal axis of the part. In addition to the side seal grooves 208 and bottom seal groove 209 previously described, recess 207 further has disposed on it an entry bevel 310 designed to aid insertion of the main pipe 210 into the recess 207. A bottom edge bevel 313 is disposed between the recess bottom 211 and the recess side 315. Further, bottom center bevel 311 is disposed between the recess bottom 211 and the wall of the fluid passage 202. These bevels may aid linear flow through the invention 200.

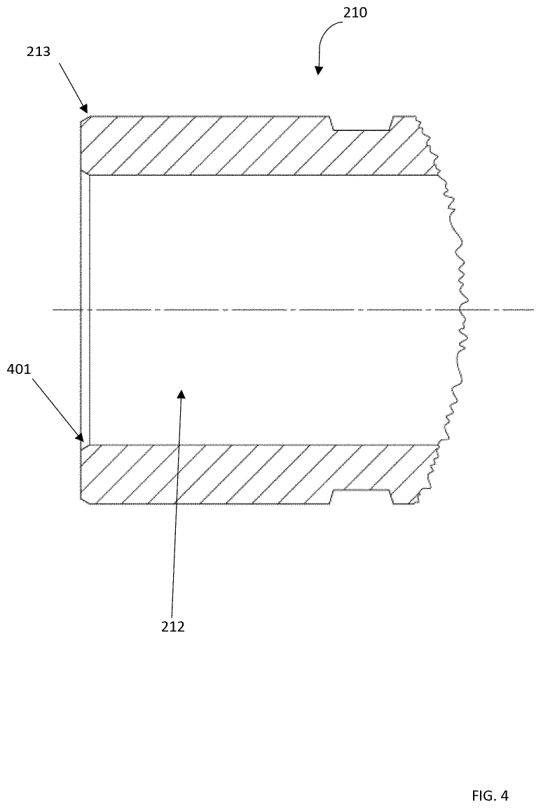

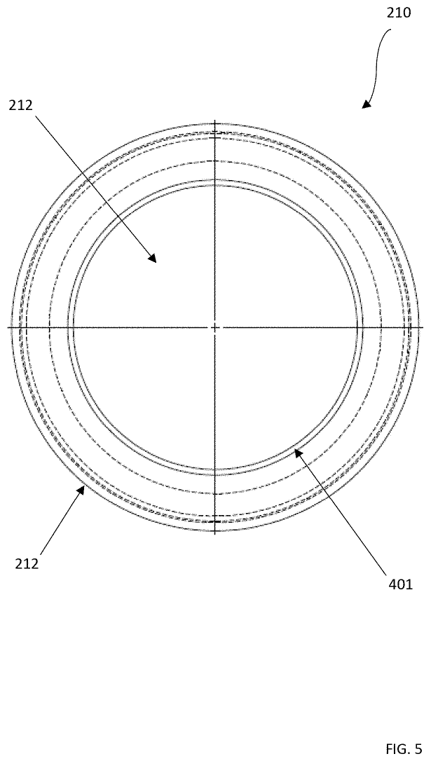

Referring now to FIG. 4, a partial cut-away side view of the main pipe 210 and fluid passage 212 are depicted. Again, the dashed line depicts the imaginary longitudinal axis of main pipe 210. FIG. 4 further depicts the bevel 213. In addition, a fluid passage bevel 401 is disposed at the end of the main pipe 210 to be inserted into recess 207 of the first mounting piece 201 to aid linear fluid flow through the invention 200. Referring further to FIG. 5, an end view of main pipe 210 showing the features of FIG. 4 is provided. FIG. 5 shows another view of fluid passage 212, bevel 213 and fluid passage bevel 401. The crosshairs of FIG. 5 are depicted to aid orientation of the figure.

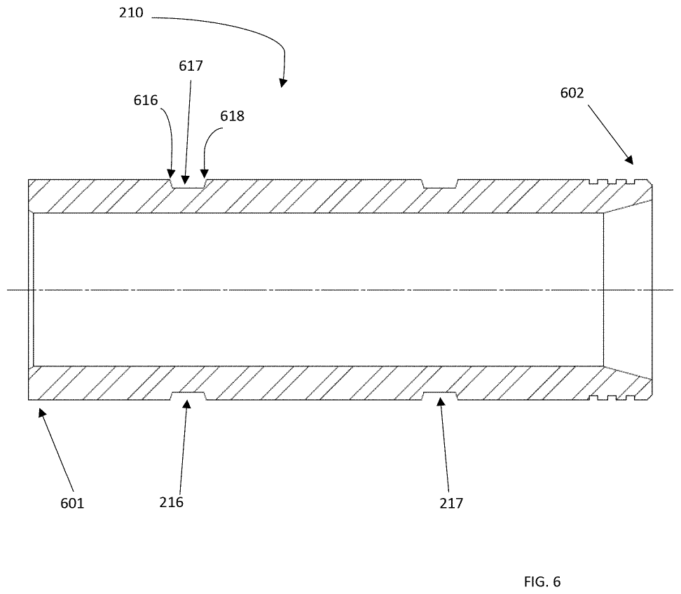

Referring now to FIG. 6, additional details of the main pipe 210, the first split ring groove 216 and the second split ring groove 217 are provided. Noting the first split ring groove 216 is positioned near the end of the main pipe 210 inserted into the recess 207 of the first mounting piece 201, the end of the main pipe 210 so inserted into recess 207 is defined as first end 601. Recess 207 (from FIG. 1) has a known depth. First split ring groove 216 is positioned a distance from the first end 601, typically about 8⅜ths inches, to ensure a secure mounting of the main pipe 210 into the first mounting piece 201. The second split ring groove 217 is positioned near the end of the main pipe 210 inserted into the second mounting piece 220. The end of the main pipe 210 so inserted into the second mounting piece 220 is identified as second end 602. Noting that the recess 227 of the second mounting piece 220 is much deeper than the recess 207 of the first mounting piece in order to permit a variable length to the invention 200 when the parts are assembled, the distance from the second end 602 of the main pipe 210 to the second split ring groove 217 must be a distance which permits secure attachment of the main pipe 210 to the second mounting piece 220 at whatever depth the main pipe 210 is inserted into the second mounting piece 220 (fully inserted or partially inserted).

As previously described, main pipe 210 may be manufactured in different sizes. In the preferred embodiment, a single second split ring groove 217 is cut or otherwise formed in the main pipe 210 regardless of the length of the main pipe 210. In alternate embodiments, a plurality of second split ring grooves 217 may be disposed on the main pipe 210. In some work situations, it is noted it may be useful to bring a single main pipe 210 although it is not known the specific length of main pipe 210 needed for the task. The plurality of second split ring grooves 217 are disposed at regular intervals along main pipe 210, typically at 12 inch intervals. In this alternate embodiment, a main pipe 210 on which a plurality of second split ring grooves 217 are disposed is cut to a usable length on-site.

FIG. 6 further depicts the shape of each of the first split ring groove 216 and the second split ring groove 217. The shape of each split ring groove 216 and 217 relevant to this disclosure is identical to the other so that only the shape of the first split ring groove 216 is described in detail here. First split ring groove 216 has a first wall 616, a second wall 618 and a bottom 617 as depicted in FIG. 6. First wall 616 is cut or otherwise formed in main pipe 210 at an angle of between 105 degrees and 111 degrees, but optimally at 108 degrees relative to bottom 617. An angle of 108 degrees for each groove yields a 36 degree included angle between the two. Likewise, second wall 618 is cut or formed in main pipe 210 at an angle of between 105 degrees and 111 degrees, but optimally at 108 degrees relative to bottom 617. The wall angles of the second split ring groove 217 are the same as those of the first split ring groove 216.

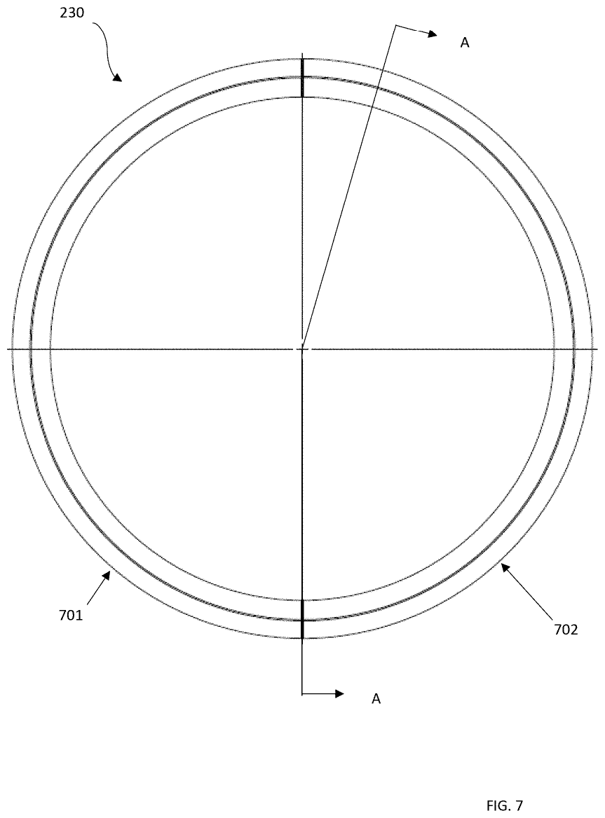

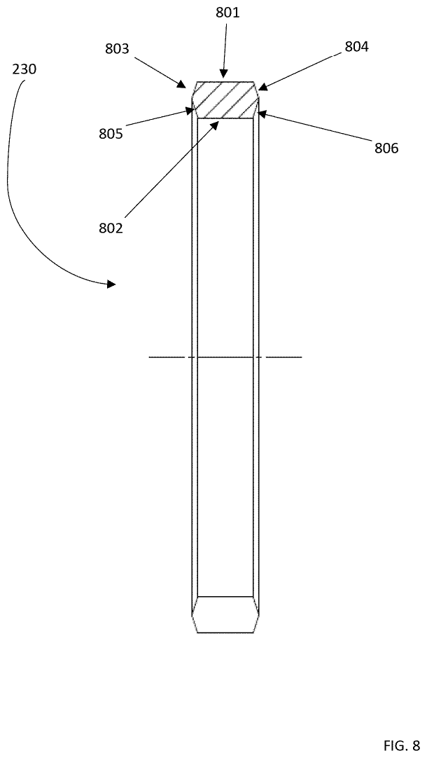

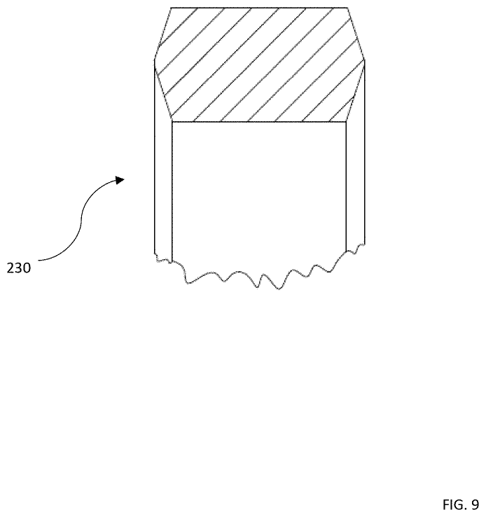

Referring now to FIG. 7, a side view of split ring 230 is depicted. The crosshairs depicted are provided for orientation of the figure. Each split ring 230 is comprised of two sections 701 and 702 of equal size made by cutting a single ring in half along an imaginary diameter. FIG. 7 depicts imaginary line A-A which is used to depict the cross section of split ring 230 in FIG. 8. Referring now to FIG. 8, the cross section of split ring 230 along line A-A of FIG. 7 is shown. The inner diameter of split ring 230 is sized to match the diameter of each of the first split ring groove 216 and the second split ring groove 217 as cut into the main pipe 210. FIG. 8 identifies the cross-sectional shape of the split ring as an elongated hexagon. The cross-section may also be described as that of two isosceles trapezoids joined at their bases. Referring still to FIG. 8, along the cross section, split ring 230 has a top 801, a bottom 802, a side one top 803, a side one bottom 805, a side two top 804 and a side two bottom 806. The angle between bottom 802 and each of side one bottom 805 and side two bottom 806 is between 105 degrees and 111 degrees but optimally 108 degrees. Likewise, the angle between top 801 and each of side one top 803 and side two top 804 is between 105 degrees and 111 degrees but optimally 108 degrees. The dashed line drawn orthogonally to the split ring 230 depicts the imaginary longitudinal axis of the part. FIG. 9 depicts a detail of FIG. 8 for clarity. While some variability of the wall angles of the first split ring groove 216, second split ring groove 217 and the split ring 230 may vary in practice as disclosed, in practice the wall angle of each split ring groove 216 and 217 must match the comparable angle of the walls of the split ring 230.

Referring to FIG. 8, FIG. 7 and FIG. 6 together, it is seen that when split ring 230 is positioned in either first split ring groove 216 or second split ring groove 217, the size and shape of split ring 230 is such that bottom 805, side one bottom 805 and side two bottom 806 fit snugly into, respectively bottom 617, first wall 616 and second wall 618 of either split ring groove 216 or 217. Side one top 803, side two top 804 and top 802 extend above the surface 218 of the main pipe 210 when the split ring 230 is in place ins a split ring groove 216 or 217.

Referring back to FIG. 2, it noted that flange groove 243 of flange 240 has a flange groove side 244 and a flange groove back 245. The angle between flange groove side 244 and flange groove back 245 is likewise cut to match the angle of the walls of the split ring 230. That is, the angle between flange groove side 244 and flange groove back 245 is between 105 degrees and 111 degrees but optimally 108 degrees.

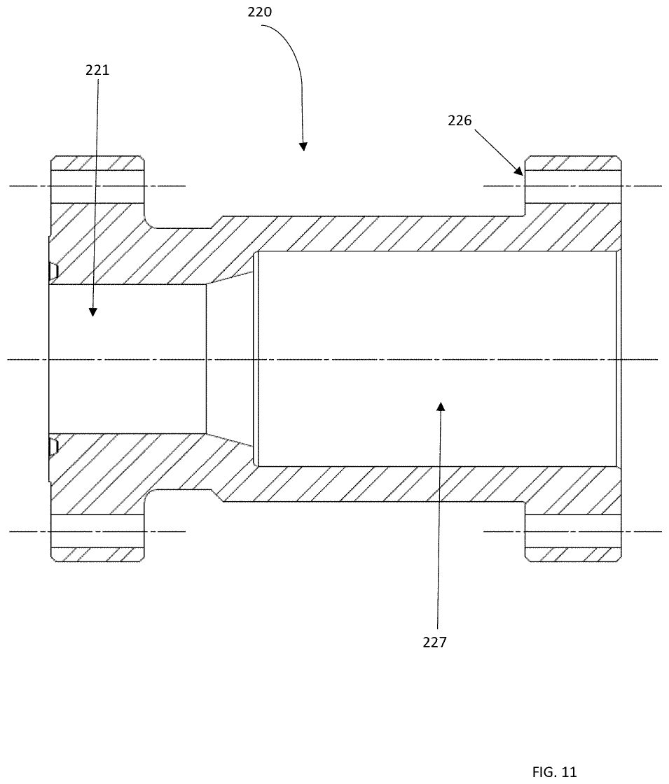

Referring now to FIG. 11, a cross-sectional depiction of second mounting piece 220 is provided. Dashed lines in FIG. 11 depict the imaginary longitudinal axis of second mounting piece 220 as well as the longitudinal axes of through holes 226. Referring also to FIG. 2, it is noted first mounting piece 201 has a length shorter than the length of second mounting piece 220. It is noted the fluid passage 202 of the first mounting piece 201 has approximately the same length as the fluid passage 221 of the second mounting piece 220. The recess 207 of the first mounting piece 201 has a depth less than or equal to the length of the fluid passage 202 of the first mounting piece 201. The first end of main pipe 210 is inserted the entire length of the recess 207 of the first mounting piece 201. The depth of recess 207 of the first mounting piece 201 must be long enough to permit a secure mounting of the first end of the main pipe 210 to the bottom of the recess 207 of the first mounting piece. For example, where the outer diameter of the main pipe 210 is approximately 10.5 inches, the depth of recess 207 of the first mounting piece 201 is approximately 5 inches.

By comparison, as shown in FIG. 11, the recess 227 of the second mounting piece 220 for the same 10.5 inch diameter main pipe 210 is approximately 18 inches deep. This depth exceeds the total depth the main pipe 210 is to be inserted into recess 227 of the second mounting piece 220. This is an important element of the invention 200. In assembling the components of the invention 200, main pipe 210 is inserted into recess 227 of the second mounting piece 220 as much as needed to span the gap in the pipeline to be connected by the invention 200. Referring also to FIG. 2, the limit on insertion of the main pipe 210 into the second mounting piece 220 is bounded on one side by the spacing and position of the seal grooves 215 and the second split ring groove 217 on the main pipe 210. Specifically, the main pipe 210 must be inserted into the recess 227 of the second mounting piece 220 far enough that the seal grooves 215 and seals (not depicted) are within said recess 227. However, the main pipe 210 must not be inserted so far that the second split ring groove 217 cannot be operationally used when assembling the invention 200. The specific typical sizes of the main pipe 210 described above in light of the depth of the recess 227 permits a broad range of functional sizes of the invention 200 to span any typical gap in a pipeline.

Referring now to FIG. 2, each flange 240 is described. Flange 240 is a generally flat disk in shape with a central hole 241 with a diameter just large enough compared to the outer diameter of the main pipe 210 to permit the main pipe 210 to be inserted through the central hole 241 snugly. Flange 240 has disposed in a circular pattern near its outer perimeter a plurality of bolt holes 242. The pattern of the plurality of bolts 242 in each flange 240 matches the pattern of the plurality of through holes 226 in second flange 224 of the second mounting piece 220 and the blind holes 206 of the second flange 204 of the first mounting piece 201.

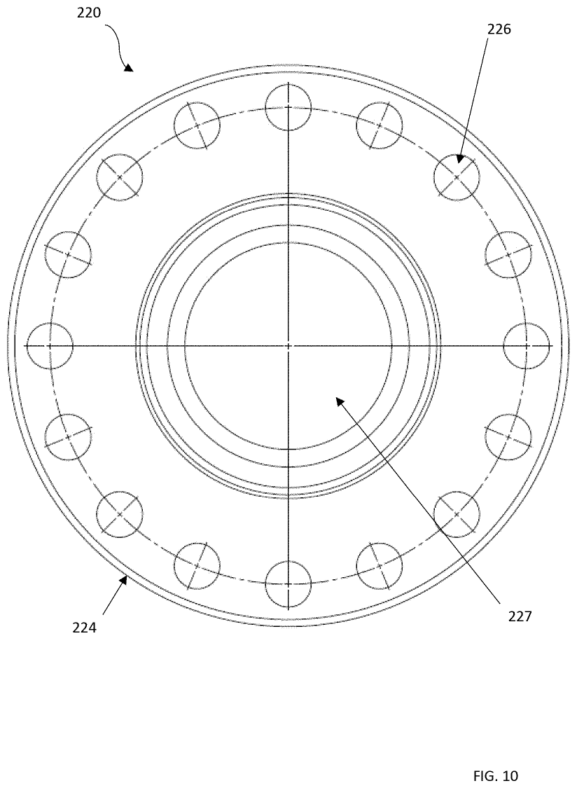

FIG. 10 depicts an end view of the second mounting piece 220 looking into the recess 227. The crosshairs and dashed lines depicted in FIG. 10 are provided to clarify the position of through holes 226 and other aspects of this part. This figure further depicts the plurality of through holes 226 along the perimeter of the second flange 224 of the second mounting piece 220. The pattern of the plurality of through holes 226 matches the similar bolt holes 242 in each of flanges 240 as well as the through holes 226 of first flange 223 of the second mounting piece 220 and the through holes 205 of the first flange 203 and the blind holes 206 of the second flange 204 of the first mounting piece 201 in order to permit the invention 200 to be assembled.

Referring now to FIG. 2 and FIG. 12, the assembly and advantages of the invention 200 are described. To connect the ends of a gap in a pipeline in which the length of the gap is sufficiently approximately known (that is, sufficiently known to determine the size of main pipe 210 to be used), a main pipe 210 is selected for use. In this FIG. 12, a main pipe 210 on which a plurality of second split ring grooves 217 are disposed is depicted. A flange 240 is disposed toward the end of the main pipe 210 on which the first mounting piece 201 is to be assembled. The flange groove 243 of flange 240 is positioned toward the end of the main pipe 210 on which the first mounting piece 201 is assembled. The flange 240 must be positioned between the first split ring groove 216 and the second split ring groove 217. Next, a split ring 230 is placed in the first split ring groove 216 and flange 240 is slid into place by sliding flange 240 in the direction of the first mounting piece 201 until the split ring 230 is in place in the flange groove 243 of the flange 240.

Next, seal rings (not depicted) are disposed in the side seal grooves 208 and bottom seal groove 209 of the first mounting piece 201. Once in place, the first mounting piece 201 is pressed into place on the end of main pipe 210. The inserted end of the main pipe 210 must be pressed against the bottom 211 of the first mounting piece 201. In order to bolt these parts together, one or both of the main pipe 210 and first mounting piece 201 are rotated along their longitudinal axes until the blind holes 206 of the first mounting piece 201 are aligned with the bolt holes 242 of the flange 240. The blind holes 206 of the first mounting piece 201 are threaded. The bolts holes 242 of the flange 240 are not and are large enough to let suitably sized all threads to pass through each. One all thread 1201 is inserted through one bolt hole 242 and threaded into a blind hole 206 and tightened. This is repeated for each bolt hole 242 and blind hole 206 in the flange 240 and first mounting piece 201. A nut 1202 is then threaded onto each all thread 1201 and tightened. The secure mounting of the main pipe 210 to the first mounting piece 201 is accomplished by the angled surfaces of the first split ring groove 216, split ring 230 and flange groove 243. Referring also to FIG. 3, FIG. 4, FIG. 6 and FIG. 8, flange groove back 245 is pressed against side two top 804 of the split ring 230. This presses side one bottom 805 of the split ring 230 against the first wall 616 (see FIG. 6) of the first split ring groove 216 of the main pipe 210. By angling the walls of the first split ring groove 216, the split ring 230 and the flange groove 243 as described herein, the split ring 230 is subjected almost entirely to compressive forces instead of shear forces to hold the main pipe 210 in place in the first mounting piece 201. This permits a stable expansion spool assembly and allows the invention 200 to be used in higher pressure applications.

In a similar manner, a second flange 240 is disposed on the main pipe 210 to mount the second mounting piece 220. In this case, the flange groove 243 of the flange 240 is placed on the side toward the second mounting piece 220. The flange 240 is disposed along the main pipe 210 at least past the second split ring groove 217 toward the first mounting piece 201. A split ring 230 is disposed in the second split ring groove 217 and the flange 240 is slid into place against the split ring 230. Seals (not depicted) and placed into the plurality of seal grooves 215 on the main pipe 210. The main pipe 210 is then inserted into the recess 227 of the second mounting piece 220. The depth of recess 227 permits the worker to lengthen or shorten the overall length of the invention 200 to fit exactly the gap in the pipeline. Once the proper length is determined (which may be on the ground prior to installation or during installation), the second mounting piece 220 and flange 240 are rotated along the longitudinal axis of one or both parts so as to align bolt holes 226 of the second mounting piece 220 and bolt holes 241 of the flange. One all thread 1210 is inserted through one each of bolts holes 226 and bolt holes 241. Then, the worker threads into place three nuts 1202 as depicted in FIG. 12. Again, the angled walls of the split ring 230 relative to the angled walls of each of the flange groove 243 and second split ring groove 217 ensure the second mounting piece 220 is mounted to the main pipe 210 under compressive forces acting on the split ring 230 and not shear forces.

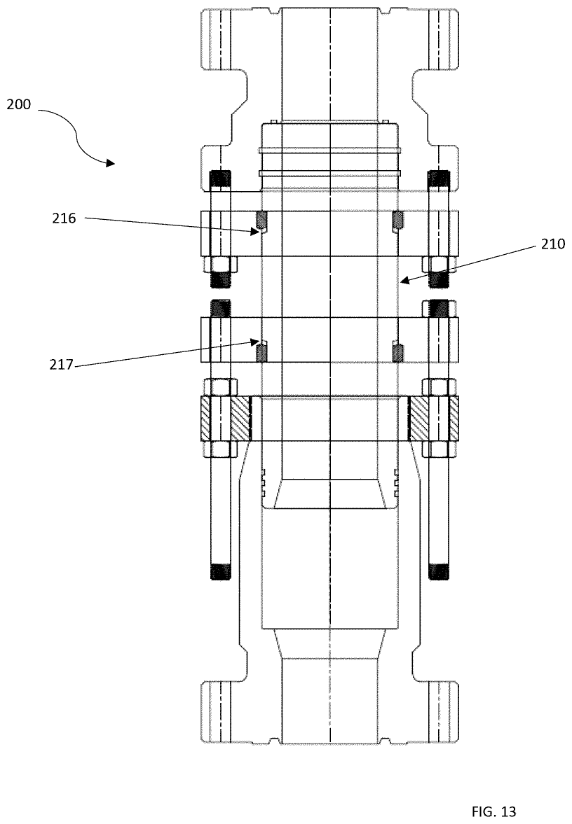

FIG. 13 depicts another view of the assembly of the invention 200 in which the main pipe 210 has a single first split ring groove 216 and a single second split ring groove 217.

We claim:

1. An adjustable expansion spool capable of fluidly connecting the open ends of a gap in a pipeline comprising:
a main pipe having disposed thereon at least two grooves each of which groove is shaped and sized to accommodate a portion of a complementarily shaped and sized split ring;
in which the main pipe further comprises a fluid channel, a first end and a second end;
in which the first end of the main pipe is fluidly engageable into a recess disposed in a first mounting piece;
in which the first mounting piece has a fluid channel, a first end and a second end in which the first end of the first mounting piece comprises a flange suitable to be attached to one open end of a gap in a pipeline to fluidly connect the first mounting piece to the open end of a pipeline;
in which the second end of the first mounting piece has disposed thereon a flange suitable to be connected to a separate flange and a recess sized and shaped to receive the first end of the main pipe fully inserted into the recess;
a split ring sized and shaped to fit a portion thereof into the split ring groove disposed near the first end of the main pipe while workably exposing a portion of the split ring above the surface of the main pipe;
a separate flange sized and shaped to attach to the first end of the main pipe and on which is disposed a recess sized and shaped to receive the exposed portion of the split ring above the split ring groove;
in which the separate flange and the flange on the second end of the first mounting piece are removably attachable so as to secure the main pipe in the recess of the first mounting piece through compressive forces applied by the separate flange against the exposed portion of the split ring which compresses the split ring portion in the split ring groove against the wall of the split ring groove to secure the main pipe in the first mounting piece;
in which the second end of the main pipe is fluidly engageable at a variable depth into a recess disposed in a second mounting piece;
in which the second mounting piece has a fluid channel, a first end and a second end:
in which the first end of the second mounting piece comprises a flange suitable to be attached to the second open end of a gap in a pipeline to fluidly connect the second mounting piece to an open end of a pipeline;
in which the second end of the second mounting piece has disposed thereon a flange suitable to be connected to a separate flange and a recess sized and shaped to receive a variable portion of the second end of the main pipe in the recess to the extent necessary for the invention to span the gap in a pipeline;
a second split ring sized and shaped to fit a portion of the second split ring into a second split ring groove disposed near the second end of the main pipe while workably exposing part of the second split ring above the surface of the main pipe;
a second separate flange sized and shaped to fit on the second end of the main pipe and on which is, disposed a recess sized and shaped to receive the exposed portion of the second split ring above the second split ring groove;
in which the second separate flange and the flange on the second end of the second mounting piece are removably attachable so as to secure as much of the second end of the main pipe as necessary to span the gap in the pipeline in the recess of the second mounting piece through compressive forces applied by the second separate flange against the exposed part of the second split ring which compresses the second split ring portion in the second split ring groove against the wall of the second split ring groove to secure the main pipe in the second mounting piece.

2. The invention of claim 1 in which the main pipe has disposed thereon a plurality of shaped grooves.

3. The invention of claim 1 in which the cross-sectional shape of the split ring is an elongated hexagon.

4. The invention of claim 3 in which the angle between the base of the elongated hexagon and a side wall of the elongated hexagon is between 105 degrees and 111 degrees.

5. The invention of claim 3 in which the angle between the base of the elongated hexagon and the side wall of the elongated hexagon is 108 degrees. A shaped split ring suitable to secure a pipe mounting piece to a pipe
in which the pipe has disposed thereon a shaped split ring groove
in which the split ring groove is sized and shaped to contain portion of the shaped split ring groove
in which a separate flange has disposed therein a central passage through which the pipe is inserted and further in which the separate flange has a sized and shaped recess to receive that portion of the shaped split ring exposed above the surface of the pipe
in which the pipe is inserted into a pipe mounting piece in which further the pipe mounting piece comprises a flange
in which when the separate flange is connected to the flange of the pipe mounting piece to apply force upon the shaped and sized split ring, the force applied is compressive force
so as to secure the pipe in in the pipe mounting piece under compressive forces.

6. The invention of claim 5 in which the shape of the split ring is an elongated hexagon.

7. The invention of claim 6 in which the angle between the base of the elongated hexagon and a side wall of the elongated hexagon is between 105 degrees and 111 degrees.

8. The invention of claim 7 in which the angle between the base of the elongated hexagon and the side wall of the elongated hexagon is 108 degrees.

9. The invention of claim 6 in which the sized and shaped recess in the flange is shaped to match the shape of the split ring.

10. The invention of claim 5 in which the pipe mounting piece comprises a recess to receive the pipe for mounting.

11. The invention of claim 10 in which the pipe is inserted fully into the recess of the pipe mounting piece.

12. The invention of claim 10 in which the pipe is inserted to a variable depth into the recess of the pipe mounting piece.
